SEQUENCE LISTING (1 sequence)

SEQ ID NO: 1 - DNA, 16 bp, Artificial Sequence
  Synthetic example sequence for descriptions of the invention
agctccccttttagtc

(19) United States
(12) Patent Application Publication
(10) Pub. No.: US 2013/0158885 A1
(43) Pub. Date: Jun. 20, 2013

(54) GENOME SEQUENCE MAPPING DEVICE AND GENOME SEQUENCE MAPPING METHOD THEREOF

(71) Applicant: Electronics and Telecommunications Research, Daejeon (KR)

(72) Inventor: Chan Yong PARK, Daejeon (KR)

(73) Assignee: Electronics and Telecommunications Research Institute, Daejeon (KR)

(21) Appl. No.: 13/672,529

(22) Filed: Nov. 8, 2012

(30) Foreign Application Priority Data
Dec. 14, 2011 (KR) 10-2011-0134730

(51) Int. Cl. G06F 19/24

(52) U.S. Cl. CPC G06F 19/24
USPC 702/20

(57) ABSTRACT

Provided are a genome sequence mapping device and a genome sequence mapping method. The genome sequence mapping device may include a controller and a genome sequence analyzer configured to map target sequence data to reference sequence data. The genome sequence analyzer transforms the reference sequence data and the target sequence data into frequency domains to determine a position of the target sequence data to be mapped among the reference sequence data. The genome sequence mapping device calculates a correlation between reference sequence data and target sequence data in a frequency domain to immediately determine whether the reference sequence data and the target sequence data match each other.

### CROSS-REFERENCE TO RELATED APPLICATIONS

This US non-provisional patent application claims priority under 35 USC §119 to Korean Patent Application No. 10-2011-0134730, filed on Dec. 14, 2011, the entirety of which is hereby incorporated by reference.

### BACKGROUND OF THE INVENTION

The present general inventive concept relates to apparatuses and methods for analyzing genome sequence.

After the draft of human genome sequence is completed, the study on genome is given a great deal of weight on the field of medicine and biology. In addition, high throughput technologies such as a microarray technology have been evolved to construct the environment in which a large amount of information can be easily obtained through only one experiment. Thus, the study on genome is becoming more important in the field of medicine and biology.

In the recent years, the next generation sequencing has been widely used in the field of medicine and biology to immediately confirm information on gene sequence. However, sequence data generated by the next generation sequencing is much smaller sequence length than sequence data generated by a conventional Sanger method. Moreover, since millions to billions of short reads may be obtained from one sample, it takes a lot of time to compare sequence data generated from the next generation sequencing with reference sequence data through a conventional a hash table or suffix tree method.

### SUMMARY OF THE INVENTION

Embodiments of the inventive concept provide a genome sequence mapping device and a genome sequence mapping method thereof.

An aspect of the inventive concept is directed to a genome sequence mapping device which may includes a controller; and a genome sequence analyzer configured to map target sequence data to reference sequence data. The genome sequence analyzer transforms the reference sequence data and the target sequence data into frequency domains to determine a position of the target sequence data to be mapped among the reference sequence data.

In an example embodiment, the genome sequence analyzer may include a coder configured to code the reference sequence data and the target sequence data into binary data, respectively.

In an example embodiment, the coder may configure the reference sequence data and the target sequence data with computer-processable units, respectively.

In an example embodiment, the genome sequence analyzer may further include a Fourier transformer configured to perform a Fourier transform operation on the coded reference sequence data and the coded target sequence data.

In an example embodiment, the genome sequence analyzer may further include a correlation calculator configured to perform a correlation calculation operation on the Fourier-transformed reference sequence data and the Fourier-transformed target sequence data.

In an example embodiment, the genome sequence analyzer may further include an inverse Fourier transformer configured to inversely Fourier-transform a result value of the correlation calculation performed by the correlation calculator.

In an example embodiment, the genome sequence analyzer may further include an optimal position determiner configured to determine a position of the target sequence data to be mapped among the reference sequence data, based on a result of the inverse Fourier transform.

In an example embodiment, the optimal position determiner may determine a position of the target sequence data to be mapped among the reference sequence data, based on sizes of a plurality of peak points of the result of the inverse Fourier transform.

In an example embodiment, the target sequence data may be genome sequence data produced by the next-generation sequencing.

In an example embodiment, length of the target sequence data may be less than that of the reference sequence data.

An aspect of the inventive concept is directed to a genome sequence mapping method which may includes transforming reference sequence data and target sequence data into frequency domains, respectively; performing a correlation calculation on the reference sequence data transformed into the frequency domain and the target sequence data into the frequency domain; and determining a matching position of the target sequence data among the reference sequence data.

In an example embodiment, the genome sequence mapping method may further include coding the reference sequence data and the target sequence data into binary data, respectively.

In an example embodiment, the genome sequence mapping method may further include converting the binary-coded reference sequence data and the binary-coded target sequence data into computer-processable units, respectively.

In an example embodiment, the genome sequence mapping method may further include converting the binary-coded reference sequence data and the binary-coded target sequence data into byte-unit data, respectively.

In an example embodiment, after performing the correlation calculation, the genome sequence mapping method may further include transforming a result of the correlation calculation into a time domain.

In an example embodiment, the target sequence data may be genome sequence data produced by the next-generation sequencing.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 is a block diagram of a genome sequence mapping device according to an embodiment of the inventive concept.

FIG. 2 is a table illustrating a binary coding method of genome sequence according to an embodiment of the inventive concept.

FIGS. 3 to 7 illustrate the operation of the genome sequence mapping device in FIG. 1. FIG. 6 includes SEQ ID NO: 1.

FIG. 8 is a flowchart illustrating the operation of the genome sequence mapping device in FIG. 1.

### DETAILED DESCRIPTION

The inventive concept will now be described more fully hereinafter with reference to the accompanying drawings, in which preferred embodiments of the inventive concept are shown.

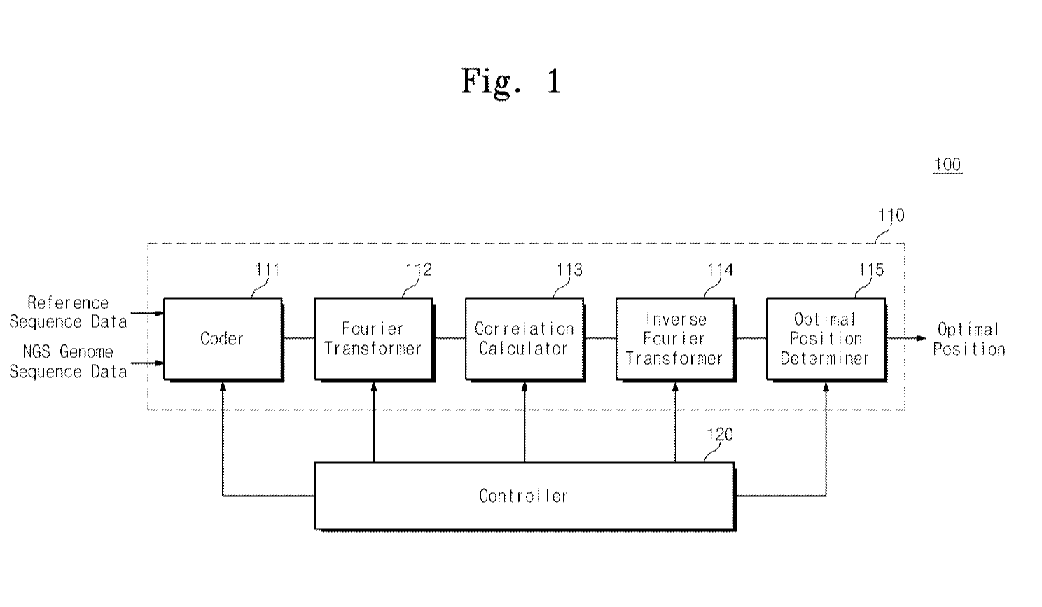

Reference is made to FIG. 1, which is a block diagram illustrating a genome sequence mapping device 100 according to an embodiment of the inventive concept. The genome sequence mapping device 100 includes a genome sequence analyzer 110 and a controller 120.

The genome sequence analyzer 110 transforms reference sequence data and genome sequence data obtained from the next-generation sequencing scheme (hereinafter referred to as “NGS genome sequence data”) into frequency domains in response to the control of the controller 120 to determine a position where the NGS genome sequence data among the reference sequence data is to be mapped. The genome sequence analyzer 110 includes a coder 111, a Fourier transformer 112, a correlation calculator 113, an inverse Fourier transformer 114, and an optimal position determiner 115.

The coder 111 receives reference sequence data and NGS genome sequence data. The NGS genome sequence data is data generated from the next-generation sequencing and is shorter than the reference sequence data. For example, the reference sequence data may have a sequence of “AGCTCCCCTTTTAGTC” (SEQ ID NO: 1), and the NGS genome sequence data may have a shorter sequence of “CCCCTTTT” than the reference sequence data. However, these sequences are just exemplary and the reference sequence data and the NGS genome sequence data may include various types of combinations.

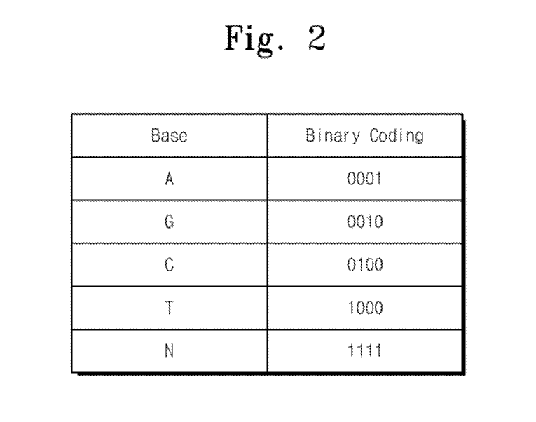

The coder 111 codes the reference sequence data and the NGS genome sequence data to binary data, respectively. For example, the coder 111 may perform binary coding on the reference sequence data and the NGS genome sequence data by using the table in FIG. 2. However, the table in FIG. 2 is exemplary and “A” is not necessarily “0001”. In the table in FIG. 2, “N” represents a part where sequence among the NGS genome sequence data is not determined and may be coded into “1111”, as shown in FIG. 2. The coded NGS genome sequence data is shorter than the coded reference sequence data. Accordingly, a padding part is filled with “0000” such that the coded NGS genome sequence data has the same length as the coded reference sequence data.

The coder 111 may include a unit where the coded reference sequence data and the coded NGS genome sequence data can be processed by a computer. For example, the coder 111 may configure the coded reference data and the coded NGS genome sequence data in units of bytes.

Specifically, let it be assumed that the NGS genome sequence is “AGTC” and is binary-coded using the table in FIG. 2. In this case, the coder 111 performs binary coding on the NGS genome sequence into “0001001010000100”. Since one base (or DAN code) (e.g., “A”) is equivalent to 4 bits, two bases are allocated to one byte (8 bits). In addition, “0001001010000100” is equivalent to 2 bytes and is expressed as “1284” in hexadecimal format. As a result, the coder 111 may convert the NGS genome sequence of “AGTC” into “1284” in hexadecimal format.

For the convenience of explanation, coded reference sequence data and coded NGS genome sequence data converted into computer-processable unit will be hereinafter referred to as reference sequence alignment and NGS genome sequence alignment, respectively.

Continuing to refer to FIG. 1, the Fourier transformer 112 receives reference sequence alignment and NGS genome sequence alignment from the coder 111. The Fourier transformer 112 performs Fourier transform on the reference sequence alignment and the NGS genome sequence alignment, which means that the reference sequence alignment and the NGS genome sequence alignment are transformed into frequency domains by the Fourier transformer 112, respectively. The Fourier transformer 112 may be configured with a graphic processing unit (GPU) using compute unified device architecture (CUDA) or open computing language (OpenCL), configured to perform parallel processing using a system thread, or configured with a many integrated core (MIC).

The correlation calculator 113 receives the Fourier-transformed reference sequence alignment and the Fourier-transformed NGS genome sequence alignment from the Fourier transformer 112. The correlation calculator 113 performs correlation calculation on the Fourier-transformed reference sequence alignment and the Fourier-transformed NGS alignment. For example, the correlation calculator 113 performs conjugate on one of the Fourier-transformed reference sequence alignment and the Fourier-transformed genome sequence alignment and then multiplies elements of the two sequence alignments with respect to the two sequence alignments.

The inverse Fourier transformer 114 receives a result of the correlation calculation from the correlation calculator 114 and performs inverse Fourier transform on the result of the correlation calculation. The optimal position determiner 115 receives a result of the inverse Fourier transform from the inverse Fourier transformer 114 and determines a matching position of NGS genome sequence data among the reference sequence data by using the result of the inverse Fourier transform.

For example, the optimal position determiner 115 determines a position of reference sequence data corresponding to the greatest value among result values of inverse Fourier transform as a matching position of NGS genome sequence data.

As discussed above, the genome sequence mapping device 100 according to an embodiment of the inventive concept may transform reference sequence data and NGS genome sequence data into frequency domains, respectively and performs correlation calculation thereon to determine a matching position of NGS genome sequence data among the reference sequence data. That is, the genome sequence mapping device 100 may map the NGS genome sequence data to reference sequence data by transforming genome sequence data into a frequency domain. By performing a comparison operation (i.e., correlation calculation) in a frequency domain, the genome sequence mapping device 100 according to an embodiment of the inventive concept may perform a mapping operation at high speed.

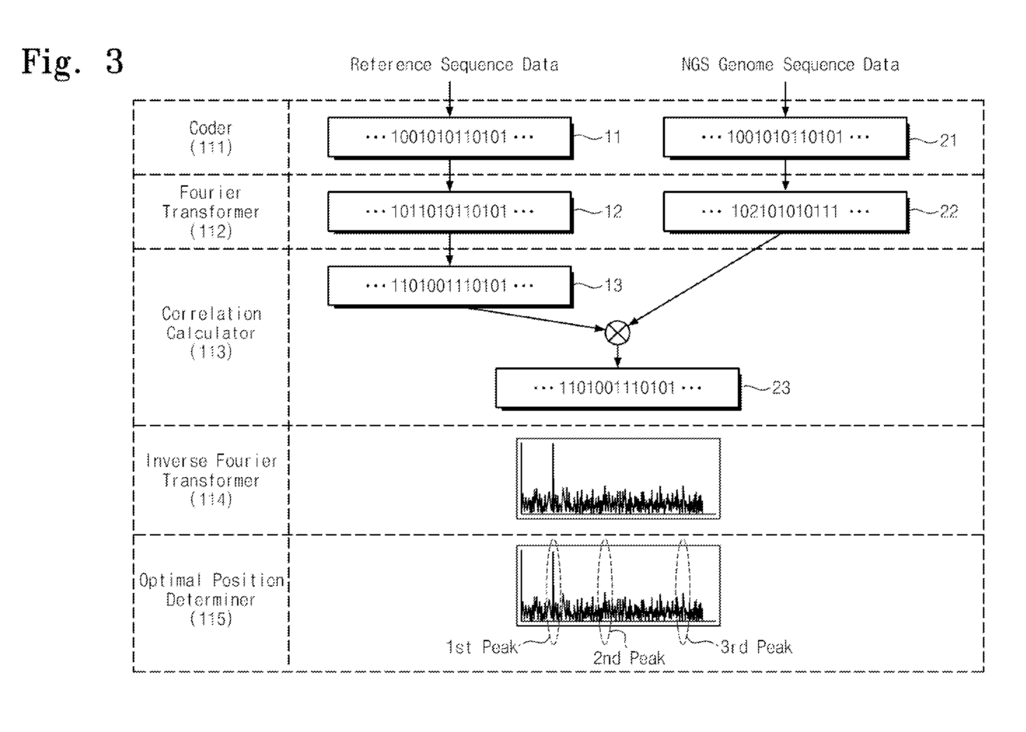

Reference is made to FIGS. 3 to 7, which illustrate the operation of the genome sequence mapping device 100 in FIG. 1.

Referring to FIG. 3, reference sequence data and NGS genome sequence data are binary-coded by the coder 111, respectively. In FIG. 3, for the convenience of explanation, let it be assumed that the coded reference sequence data 11 has a value of “1001010110101” and the coded NGS genome sequence data 21 has a value of “1001010110101”.

The coded reference sequence data 11 and the coded NGS genome sequence data 21 may be converted into a computer-processable unit by the coder 111. For example, the coded reference sequence data 11 and the coded NGS genome sequence data 21 may be converted into hexadecimal reference sequence alignment and hexadecimal NGS genome sequence alignment.

Coded reference sequence data 11 or reference sequence alignment (not shown) is Fourier-transformed by the Fourier transformer 112. Similarly, coded NGS sequence data 21 or NGS sequence alignment (not shown) is Fourier-transformed by the Fourier transformer 112. In FIG. 3, for the convenience of explanation, let it be assumed that Fourier-transformed reference sequence alignment 12 has a value of “1011010110101” and Fourier-transformed NGS genome sequence alignment 22 has a value of “102101010111”.

One of the Fourier-transformed reference sequence alignment 12 and the Fourier-transformed NGS genome sequence alignment 22 is conjugated by the correlation calculator 113. For example, as shown in FIG. 3, the correlation calculator 113 may perform a conjugate operation on the Fourier-transformed reference sequence alignment 12. In FIG. 3, for the convenience of explanation, let it be assumed that reference sequence alignment subjected to a conjugate operation (hereinafter referred to as “complex reference sequence alignment”) has a value of “1101001110101”.

In addition, the correlation calculator 113 multiplies elements of the complex reference sequence alignment 13 and the Fourier-transformed NGS genome sequence alignment 22 with respect to the two sequence alignments 13 and 22. In FIG. 3, for the convenience of explanation, let it be assumed that a correlation calculation result 23 has a value of “1101001110101”.

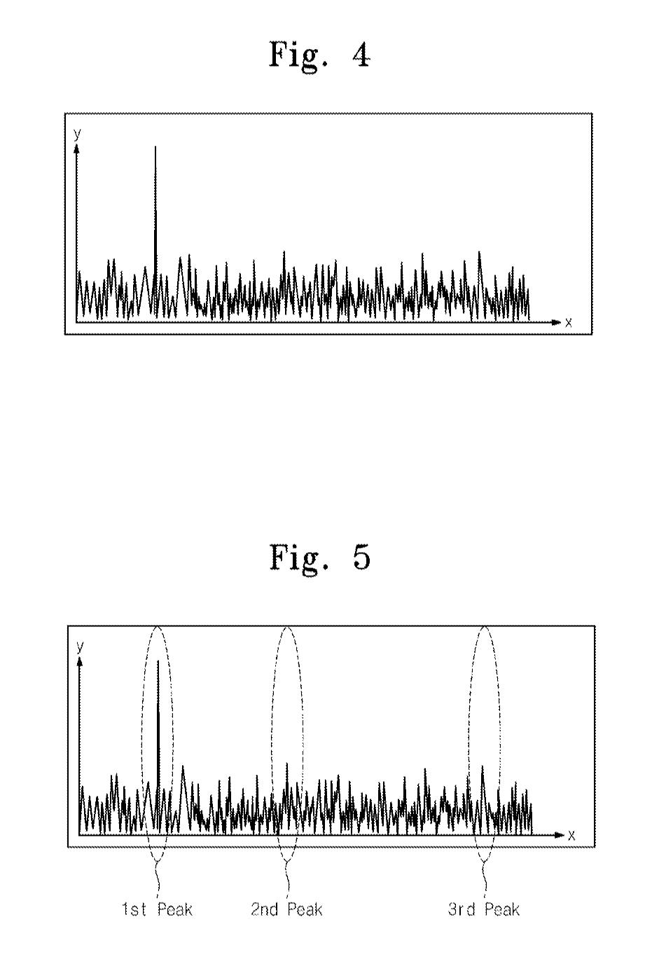

The correlation calculation result 23 is inversely Fourier-transformed by the inverse Fourier transformer 114. For example, an inversely Fourier-transformed result may have a graph in FIG. 4. The optimal position determiner 115 determines a matching part of NGS genome sequence data among the reference sequence data, based on the inversely Fourier-transformed result.

For example, as shown in FIG. 5, the optimal position determiner 115 detects first to fourth peaks from the inversely Fourier-transformed result and determines a position of the first peak having the greatest value, among the first to third peaks, as a part where reference sequence data and NGS genome sequence data match each other.

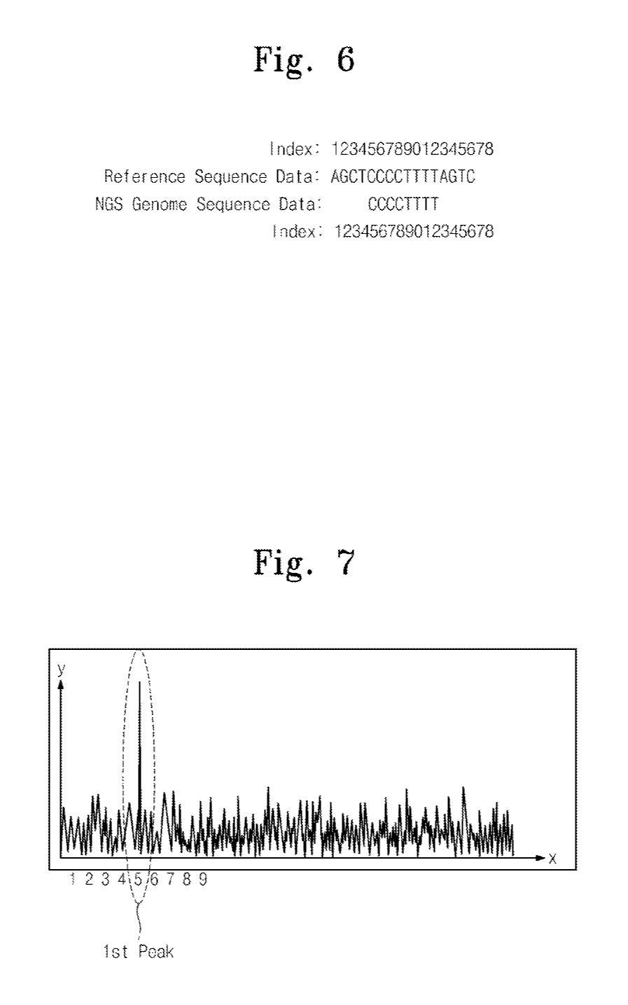

More specifically, as shown in FIG. 6, let it be assumed that reference sequence data and NGS genome sequence data have sequences of “AGCTCCCCTTTTAGTC” (SEQ ID NO: 1), and “CCCCTTTT”, respectively. Additionally, let it be assumed that the reference sequence data has unique indices depending on positions. In this case, as shown in FIG. 7, a first peak of the inversely Fourier-transformed result corresponds to an index of “5” among indices of the reference sequence data, and the optimal position determiner 115 may determine that the NGS genome sequence data matches a position corresponding to the index “5” among the reference sequence data.

As a result, the genome sequence mapping device 100 according to an embodiment of the inventive concept may detect a part where reference sequence data and NGS genome sequence data match each other and map the NGS genome sequence data to the reference sequence data.

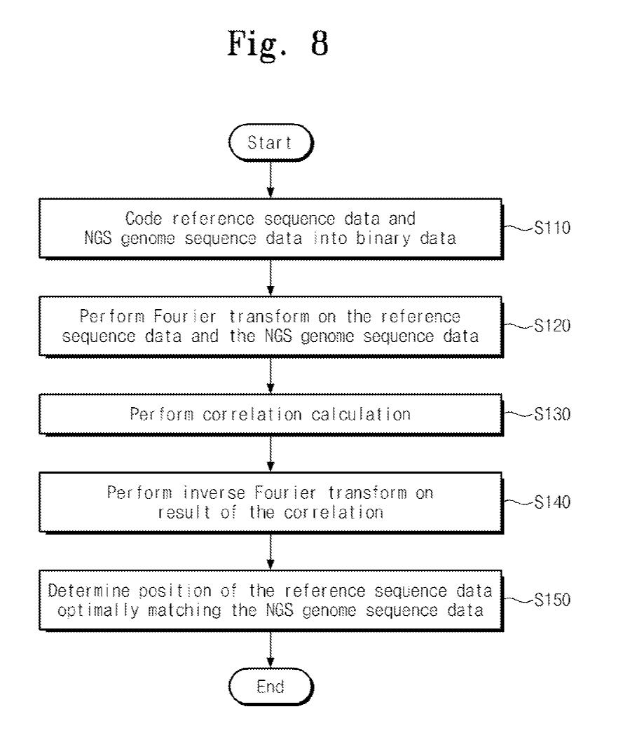

Reference is made to FIG. 8, which is a flowchart illustrating the operation of the genome sequence mapping device 100 in FIG. 1.

At step S110, the coder 110 codes reference sequence data and NGS genome sequence data into binary data, respectively. In addition, the coder 110 converts the coded reference sequence data and the coded NGS genome sequence data into reference sequence alignment and NGS genome sequence alignment such that a computer may process the reference sequence alignment and the NGS genome sequence alignment, respectively.

At step S120, the Fourier transformer 120 performs Fourier transform operations on the reference sequence alignment and the NGS genome sequence alignment, respectively.

At step S130, the correlation calculator 130 performs correlation on the Fourier-transformed reference sequence alignment and the Fourier-transformed NGS genome sequence alignment. For example, the correlation calculator 130 performs a conjugate operation on one of the Fourier-transformed reference sequence alignment and the Fourier-transformed NGS genome sequence alignment and then multiplies elements of these sequence alignments.

At step S140, the inverse Fourier transformer 140 performs an inverse Fourier transform operation on a result value of the correlation calculation. At step S150, the optimal position determiner 150 determines a position of the reference sequence data which optimally matches the NGS genome sequence data

As described so far, a genome sequence mapping device according to an embodiment of the inventive concept calculates a correlation between reference sequence data and target sequence data in a frequency domain to immediately determine whether the reference sequence data and the target sequence data match each other.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A genome sequence mapping device comprising:
a controller; and
a genome sequence analyzer configured to map target sequence data to reference sequence data,
wherein the genome sequence analyzer transforms the reference sequence data and the target sequence data into frequency domains to determine a position of the target sequence data to be mapped among the reference sequence data.

2. The genome sequence mapping device as set forth in claim 1, wherein the genome sequence analyzer comprises a coder configured to code the reference sequence data and the target sequence data into binary data, respectively.

3. The genome sequence mapping device as set forth in claim 2, wherein the coder configures to compose the reference sequence data and the target sequence data with computer-processable units, respectively.

4. The genome sequence mapping device as set forth in claim 2, wherein the genome sequence analyzer further comprises a Fourier transformer configured to perform a Fourier transform operation on the coded reference sequence data and the coded target sequence data.

5. The genome sequence mapping device as set forth in claim 4, wherein the genome sequence analyzer further comprises a correlation calculator configured to perform a correlation calculation operation on the Fourier-transformed reference sequence data and the Fourier-transformed target sequence data.

6. The genome sequence mapping device as set forth in claim 5, wherein the genome sequence analyzer further comprises an inverse Fourier transformer configured to inversely Fourier-transform a result value of the correlation calculation performed by the correlation calculator.

7. The genome sequence mapping device as set forth in claim 6, wherein the genome sequence analyzer further comprises an optimal position determiner configured to determine a position of the target sequence data to be mapped among the reference sequence data, based on a result of the inverse Fourier transform.

8. The genome sequence mapping device as set forth in claim 7, wherein the optimal position determiner determines a position of the target sequence data to be mapped among the reference sequence data, based on values of a plurality of peak points of the result of the inverse Fourier transform.

9. The genome sequence mapping device as set forth in claim 1, wherein the target sequence data is genome sequence data produced by the next-generation sequencing scheme.

10. The genome sequence mapping device as set forth in claim 9, wherein length of the target sequence data is less than that of the reference sequence data.

11. A genome sequence mapping method comprising:
transforming reference sequence data and target sequence data into frequency domains, respectively;
performing a correlation calculation on the reference sequence data transformed into the frequency domain and the target sequence data transformed into the frequency domain; and
determining a matching position of the target sequence data among the reference sequence data, based on a result of the correlation calculation.

12. The genome sequence mapping method as set forth in claim 11, further comprising:
coding the reference sequence data and the target sequence data into binary data, respectively.

13. The genome sequence mapping method as set forth in claim 12, further comprising:
converting the binary-coded reference sequence data and the binary-coded target sequence data into computer-processable units, respectively.

14. The genome sequence mapping method as set forth in claim 11, wherein the computer-processable unit is a unit of byte.

15. The genome sequence mapping method as set forth in claim 11, further comprising:
performing inverse Fourier transform on a result of the correlation calculation after performing the correlation calculation.

16. The genome sequence mapping method as set forth in claim 15, wherein a step of the determining a matching position of the target sequence data among the reference sequence data includes determining a position of the target sequence data to be mapped among the reference sequence data, based on values of a plurality of peak points of the result of the inverse Fourier transform.

17. The genome sequence mapping method as set forth in claim 11, wherein the target sequence data is genome sequence data produced by the next-generation sequencing scheme.

18. The genome sequence mapping method as set forth in claim 11, wherein length of the target sequence data is less than that of the reference sequence data.
